(19) United States
(12) Patent Application Publication
(10) Pub. No.: US 2017/0057821 A1
(43) Pub. Date: Mar. 2, 2017

(54) GRAPHITIC CARBON NITRIDE MATERIAL, AND ITS SYNTHETIC METHOD AND APPLICATIONS

(71) Applicant: INSTITUTE OF PROCESS ENGINEERING, CHINESE ACADEMY OF SCIENCES, Beijing (CN)

(72) Inventors: Hongbin CAO, Beijing (CN); Yongbing XIE, Beijing (CN); Jiadong XIAO, Beijing (CN); Yuping LI, Beijing (CN); Yuxing SHENG, Beijing (CN)

(21) Appl. No.: 15/250,981

(22) Filed: Aug. 30, 2016

(30) Foreign Application Priority Data
Aug. 31, 2015 (CN) 201510547759.6

(51) Int. Cl. C01B 21/06

(52) U.S. Cl. CPC C01B 21/0605; C01P 2004/20; C01P 2006/16; C01P 2006/14; C01P 2006/12

(57) ABSTRACT

The present invention relates to a synthetic method of graphitic carbon nitride material. The method involves a homogenous mixing of carbon nitride precursor and ammonium salt, and calcining the mixture to obtain a porous graphitic carbon nitride material. Wherein, the ammonium salt is any one or a combination of at least two which could release gaseous NH₃ during thermolysis. The present invention uses thermolabile ammonium salt as a pore former; the thermolysis of ammonium salt could release soft gas bubbles during the calcination; the later burst of bubbles leads to the formation of nanoporous structure. The proposed method is template-free and environmentally-friendly, and the resultant material exhibits high photocatalytic activity in the field of gas and water decontamination.

### TECHNICAL FIELD

The present invention relates to a material that has great potential as a catalyst in visible light photocatalysis and ozone-visible light photocatalysis for waste water and gas treatments. It specifically relates to a graphitic carbon nitride (g-C₃N₄) material, its synthetic method and applications, and especially involves a honeycomb-like nanoporous g-C₃N₄ material, its synthetic method and applications.

### BACKGROUND ART

Energy crisis and environmental pollution, as two significant issues, have been posing a great threat to human beings. Visible-light photocatalysis is considered as an efficient solution to overcome the above problems, as it can take advantage of solar energy for water and gas decontamination. In order to advance the technology of visible-light photocatalysis, it is crucial to develop inexpensive, convenient, performant and stable visible-light-responsive catalysts.

In recent years, g-C₃N₄, a metal-free visible-light-driven photocatalyst, has drawn worldwide concern. The g-C₃N₄ material can be easily obtained through direct polymerization of cheap feedstocks such as urea, cyanamide, dicyanamide and melamine. The natural narrow band gap of g-C₃N₄ is 2.70 eV, permitting it to directly absorb visible light to drive chemical reactions. Moreover, it is non-toxic and possesses high thermal and chemical stability due to its tri-s-triazine ring structure. However, the bulk g-C₃N₄ synthesized by a conventional pyrolytic method exhibits low photocatalytic efficiency due to its low specific surface area and high recombination rate of photoinduced electron-hole pairs.

Manipulating g-C₃N₄ to be nanoporous is considered as an attractive strategy to improve the photocatalytic activity as it can effectively increase the reactive sites, promote mass transfer and suppress the recombination of photoinduced charge carriers [Appl. Catal. B: Environ. 2014, 147, 229-235]. To date, conventional approaches to prepare nanoporous g-C₃N₄ include a hard-templating method (e.g., using mesoporous SiO₂ as a nanocasting agent) and a soft-templating method (e.g., using surfactants or ionic liquids to drive self-polymerization reactions). However, the hard-templating process requires a hazardous HF (or NH₄F)-based post-treatment to remove the silica template, and the soft-templating method suffers from the carbon residual impurity from the templating agents. Both approaches are also time- and energy-consuming. In addition, the g-C₃N₄ material prepared by templating methods has regular pore structure and subjects to the limitation of the structure of templates, resulting in complex adjustment and difficult manipulation.

Hence, to develop a template-free and efficient synthetic method to fabricate nanoporous g-C₃N₄ remains a significant issue.

### DISCLOSURE OF THE INVENTION

In order to overcome the above limitations, the present invention provides a convenient and template-free method which features synthetic simplicity and uses inexpensive feedstocks, making it quite appealing for large scale production of high-performance nanoporous g-C₃N₄.

The synthetic method involves a homogenous mixing of g-C₃N₄ precursor and ammonium salt, instantly followed by calcination of the mixture to obtain a porous g-C₃N₄ material. The employed ammonium salt can be any one or a combination of at least two which could release gaseous NH₃ during thermolysis.

The thermolysis of ammonium salt could release soft gas bubbles during the high-temperature calcination; the later burst of bubbles leads to the formation of honeycomb-like nanoporous architecture.

The g-C₃N₄ precursor of the present invention further comprises any one or a mixture of at least two components among cyanamide, dicyandiamide, melamine, thiourea and urea. It typically includes but does not limit to, cyanamide, dicyandiamide, a binary mixture of cyanamide and dicyandiamide, a ternary mixture of urea, cyanamide and thiourea, etc.

The ammonium salt of the present invention further comprises any one or a mixture of at least two components among NH₄F, NH₄Cl, NH₄Br, NH₄I, (NH₄)₂CO₃, NH₄HCO₃, NH₄NO₃, (NH₄)₂SO₄, NH₄HSO₄, NH₄H₂PO₄, (NH₄)₂HPO₄, (NH₄)₃PO₄ and (NH₄)₂C₂O₄. Any one or a mixture of at least two from NH₄Cl, NH₄NO₃, (NH₄)₂CO₃ and NH₄HCO₃ is preferably employed. It typically includes but does not limit to, (NH₄)₂C₂O₄, (NH₄)₂CO₃, NH₄NO₃, a binary mixture of (NH₄)₂CO₃ and NH₄HCO₃, a binary mixture of NH₄Cl and NH₄NO₃, a ternary mixture of (NH₄)₂CO₃, NH₄HCO₃, NH₄I, etc.

During the calcination, the thermolysis of different ammonium salts can release various kinds of gases, such as NH₃ (g) and HCl (g) (from NH₄CL), NH₃ (g), CO₂ (g) and H₂O (g) (from (NH₄)₂CO₃ or NH₄HCO₃), NH₃ (g), N₂ (g), O₂ (g), NOₓ (g) and H₂O (g) (from NH₄NO₃), NH₃ (g), CO (g), CO₂ (g) and H₂O (g) (from (NH₄)₂C₂O₄), etc.

A post-washing of the final product is requisite to remove the residue from the thermolysis of ammonium salts. The cleaning agent is water or ethanol or water-ethanol mixture.

Preferably, the mass ratio of the g-C₃N₄ precursor to the ammonium salt is 1:10-10:1, such as 1:2, 1:3, 1:4, 1:5, 1:6, 1:8, 1:9, 2:1, 3:1, 5:1, 7:1, 9:1, etc.

In the case that the mass ratio of the g-C₃N₄ precursor to the ammonium salt is over 10:1, the resultant g-C₃N₄ material exhibits low specific surface area and inapparent pore structure, and the improvements of specific surface area and pore structure are limited compared to the g-C₃N₄ material prepared without the addition of ammonium salt. In the case that the mass ratio of the g-C₃N₄ precursor to the ammonium salt is lower than 1:10, the final product exhibits a collection of fragments with poor crystal structure and low photocatalytic efficiency.

The feedstocks of this method typically include yet do not limit to, 1 part of cyanamide and 10 parts of (NH₄)₂CO₃ (by weight), 10 parts of thiourea and 1 part of NH₄Cl (by weight), 1 part of dicyanamide and 10 parts of (NH₄)₂CO₃ (by weight), 10 parts of urea and 1 part of NH₄NO₃ (by weight), 2 parts of melamine and 10 parts of NH₄NO₃ (by weight), a mixture of 10 parts of dicyanamide, 1 part of NH₄HCO₃ and 1 part of (NH₄)₃PO₄ (by weight), 5 parts of a mixture of urea and cyanamide and 5 parts of a mixture of NH₄Cl and (NH₄)₂CO₃ (by weight), etc.

The calcination temperature of this method is 400-700° C., such as 420, 450, 490, 520, 550, 580, 630, 680° C., etc.; the calcination duration is 1-6 hours, such as 2, 3, 4, 5 hours, etc.

The homogenous mixing of g-C₃N₄ precursor and ammonium salt involves dissolving of g-C₃N₄ precursor and ammonium salt in a solvent, instantly followed by removing the solvent.

Preferably, the method to remove the solvent is any one or a combination of at least two among spin evaporation, natural evaporation, heating evaporation, freeze drying and vacuum drying.

The optimal approach to remove the solvent includes the following procedures: heating and stirring the aqueous mixture of g-C₃N₄ precursor and ammonium salt at 30-90° C. for 0.5-6 hours to evaporate most solvent; further removing it all by freeze drying or vacuum drying for 12-48 hours.

The stirring condition typically includes yet does not limit to, stirring for 6 hours at 30° C., stirring for 4 hours at 45° C., stirring for 3 hours at 60° C., stirring for 1.5 hours at 70° C., stirring for 0.5 hours at 90° C., etc.

Preferably, the freeze drying temperature is from −50 to −10° C., such as −50, −40, −30, −20, −10° C., etc.; the vacuum drying temperature is 40-80° C., such as 40, 50, 60, 70, 80° C. etc.

The employed solvent is water or ethanol or water-ethanol mixture.

The present invention adopts a temperature programmed calcination process. Preferably, the temperature programmed rate is 0.5-15° C./min, such as 0.5, 2, 5, 8, 12, 15° C./min, etc.

In the case that the temperature programmed rate is above 15° C./min, the high-speed rate of gas release will lead to irregular morphology and non-uniform pore size distribution of the final sample. On the contrary, in the case that the temperature programmed rate is below 0.5° C./min, the ammonium salt will lose its efficacy as a pore former, and the resultant g-C₃N₄ material cannot form efficient pore structure.

As the optimum technical scheme, the synthetic method of the present invention includes the following steps:

(1) Mixing the g-C₃N₄ precursor and ammonium salt with a mass ratio of 1:10-10:1 in a solvent to achieve a homogenous mixture;

(2) Removing the solvent in Step (1); and

(3) Heating the resultant product in Step (2) to 400-700° C. at a rate of 0.5-15° C./min and calcining for 1-6 hours.

Despite of a facile synthetic method, another object of the present invention is to provide a honeycomb-like nanoporous g-C₃N₄ material. The pore volume of the material is 0.20-0.65 cm³/g, such as 0.22, 0.25, 0.32, 0.38, 0.44, 0.52, 0.58, 0.63 cm³/g, etc. The average pore size is 2-25 nm.

Preferably, the specific surface area of the obtained g-C₃N₄ material is higher than 100 m²/g.

Preferably, the obtained g-C₃N₄ material exhibits 1-3 times higher photocatalytic activity in p-hydroxybenzoic acid degradation, compared to the g-C₃N₄ material prepared without the addition of ammonium salt as a pore former.

The third object of the present invention is to provide applications of the honeycomb-like nanoporous g-C₃N₄ material. It can be used in the field of environmental decontamination.

Preferably, it can be used in photocatalysis or photocatalytic ozonation to degrade organic pollutants in waste gas or water.

Preferably, it can be used in photocatalysis or photocatalytic ozonation to remove volatile organic chemicals.

Preferably, it can be used in photocatalysis or photocatalytic ozonation to degrade dyes, phenolic compounds, organic acids in water, etc.

The innovative points of the present invention are listed as below, compared to the conventional approaches:

(1) The basic principle is to use the thermolabile ammonium salt as a pore former; the thermolysis of ammonium salt could release soft gas bubbles during the high-temperature calcination; the later burst of bubbles lead to the formation of nanoporous structure.

(2) The present invention provides a convenient, template-free and environmentally-friendly method which features synthetic simplicity and uses inexpensive feedstocks, making it quite appealing for large scale production of high-performance nanoporous g-C₃N₄.

(3) The speed of gas release from ammonium salt thermolysis can be adjusted through regulating the type of ammonium salt, the mass ratio of the g-C₃N₄ precursor to the ammonium salt, and the calcination temperature rising speed. Optimal pore forming speed and pore diameter and distribution can be acquired through this adjustment, thus resulting in the generation of honeycomb-like nanoporous structure with over 100 m²/g of specific surface area.

(4) The resultant nanoporous g-C₃N₄ material of the present invention possesses excellent photocatalytic activity; it exhibits photocatalytic p-hydroxybenzoic acid removal rate constant of 6.9×10⁻² mg/L·min, which is one more time higher than that of the bulk g-C₃N₄ material. The high specific surface area can provide more reactive sites and promote mass transfer. Moreover, the resultant nanoporous g-C₃N₄ material possesses an enlarged band gap compared to the bulk material, which can increase the redox capability of photoinduced electrons and holes and enhance its photocatalytic activity.

### BRIEF DESCRIPTION OF THE DRAWINGS

FIG. 1 shows an X-ray Diffraction (XRD) pattern of the honeycomb-like nanoporous g-C₃N₄ material from Implementation Example 1.

FIG. 2 shows a field-emission transmission electron microscopy (FETEM) image of the bulk g-C₃N₄-1 from Contrasting Example 1.

FIG. 3 shows an FETEM image of the honeycomb-like nanoporous g-C₃N₄ material from Implementation Example 1.

FIG. 4 shows a comparison curve of the pore size distributions of the honeycomb-like nanoporous g-C₃N₄ material from Implementation Example 1 and the bulk g-C₃N₄-1 from Contrasting Example 1.

### EMBODIMENTS

Herein, Examples are given in order to further outline the technical solution of the present invention.

The experimental methods of the Examples below are conventional ones, if not otherwise specified.

The materials, reagents etc. of the Examples below are commercially purchased, if not otherwise specified.

The reactants of the Examples below are analytically pure thiourea, dicyandiamide, urea, NH₄Cl, (NH₄)₂CO₃ and NH₄HCO₃. The targeted pollutant is analytically pure p-hydroxybenzoic acid.

In the Examples below, the Brunauer-Emmett-Teller (BET) surface areas are measured by an automated gas sorption analyzer (Autosorb-iQ, Quantachrome, USA) at 77K. Pore size distributions are calculated with the non-localized density functional theory method using adsorption data.

In the Examples below, the morphologies and structures of the prepared samples are investigated by field-emission transmission electron microscopy (FETEM, JEM-2100F, JEOL, Japan).

### IMPLEMENTATION EXAMPLE 1

A synthetic method of honeycomb-like nanoporous g-C₃N₄ material includes the following procedures:

(1) Adding 10 g of thiourea, 10 g of NH₄Cl and 30 mL of pure water into a beaker (100 mL);

(2) Placing the beaker in a water bath with stirring at 70° C. for 60 min to evaporate most water and to obtain a homogeneous white paste;

(3) Placing the white paste in a vacuum drying oven at 60° C. for 16 hours to completely remove water and to obtain a white solid; and

(4) Putting a crucible with the white solid inside in a muffle furnace, instantly heating the solid to 550° C. with a rate of 15° C./min and maintaining the temperature at 550° C. for 2 hours. The final product, honeycomb-like nanoporous g-C₃N₄ material, can be obtained after naturally cooling to ambient temperature.

### CONTRASTING EXAMPLE 1

The bulk g-C₃N₄ material is prepared by direct heating thiourea without the addition of NH₄Cl as a control, which is termed as the bulk g-C₃N₄-1.

### IMPLEMENTATION EXAMPLE 2

A synthetic method of honeycomb-like nanoporous g-C₃N₄ material includes the following procedures:

(1) Dispersing 10 g of dicyandiamide, 7.5 g of (NH₄)₂CO₃ and 7.5 g of NH₄HCO₃ in 60 mL of ethanol;

(2) Heating the mixture at 30° C. for 6 hours under stirring to evaporate most ethanol and to obtain a homogeneous white paste;

(3) Placing the white paste in a vacuum freeze dryer at −50° C. for 48 hours to completely remove ethanol and to obtain a white solid; and

(4) Putting a crucible with the white solid inside in a tube furnace, instantly heating the solid to 550° C. with a rate of 1° C./min under continuous air purging and maintaining the temperature at 550° C. for 4 hours. The final product, honeycomb-like nanoporous g-C₃N₄ material, can be obtained after naturally cooling to ambient temperature.

### CONTRASTING EXAMPLE 2

The bulk g-C₃N₄ material is prepared by direct calcining dicyandiamide without the addition of (NH₄)₂CO₃ and NH₄HCO₃ as a control, which is termed as the bulk g-C₃N₄-2.

### IMPLEMENTATION EXAMPLE 3

A synthetic method of honeycomb-like nanoporous g-C₃N₄ material includes the following procedures:

(1) Adding 20 g of urea and 8 g of (NH₄)₂C₂O₄ into 20 mL of water and 20 mL of ethanol;

(2) Heating the mixture at 90° C. for 0.5 hours under stirring to evaporate most ethanol and water and to obtain a homogeneous white paste;

(3) Placing the white paste in a vacuum drying oven at 80° C. for 24 hours to completely remove ethanol and water and to obtain a white solid; and

(4) Putting a crucible with the white solid inside in a muffle furnace, instantly heating the solid to 700° C. with a rate of 8° C./min and maintaining the temperature at 700° C. for 1.5 hours. The final product, honeycomb-like nanoporous g-C₃N₄ material, can be obtained after naturally cooling to ambient temperature.

### CONTRASTING EXAMPLE 3

The bulk g-C₃N₄ material is prepared by direct calcining urea without the addition of (NH₄)₂C₂O₄ as a control, which is termed as the bulk g-C₃N₄-3.

### IMPLEMENTATION EXAMPLE 4

A synthetic method of honeycomb-like nanoporous g-C₃N₄ material includes the following procedures:

(1) Adding 1 g of dicyandiamide and 10 g of (NH₄)₂CO₃ into 20 mL of water and 20 mL of ethanol;

(2) Heating the mixture at 90° C. for 0.5 hours under stirring to evaporate most ethanol and water and to obtain a homogeneous white paste;

(3) Placing the white paste in a vacuum drying oven at 80° C. for 24 hours to completely remove ethanol and water and to obtain a white solid; and

(4) Putting a crucible with the white solid inside in a muffle furnace, instantly heating the solid to 400° C. with a rate of 0.5° C./min and maintaining the temperature at 400° C. for 6 hours. The final product, honeycomb-like nanoporous g-C₃N₄ material, can be obtained after naturally cooling to ambient temperature.

### CONTRASTING EXAMPLE 4

The nanoporous g-C₃N₄ from Implementation Example 1 of CN103170358 is selected as a contrasting example, and its specific surface area and photocatalytic activity are tested.

### IMPLEMENTATION EXAMPLE 5

A synthetic method of honeycomb-like nanoporous g-C₃N₄ material includes the following procedures:

(1) Adding 10 g of urea and 1 g of (NH₄)₂C₂O₄ into 20 mL of water and 20 mL of ethanol;

(2) Heating the mixture at 90° C. for 0.5 hours under stirring to evaporate most ethanol and water and to obtain a homogeneous white paste;

(3) Placing the white paste in a vacuum drying oven at 80° C. for 24 hours to completely remove ethanol and water and to obtain a white solid; and

(4) Putting a crucible with the white solid inside in a muffle furnace, instantly heating the solid to 600° C. with a rate of 10° C./min and maintaining the temperature at 600° C. for 1 hours. The final product, honeycomb-like nanoporous g-C₃N₄ material, can be obtained after naturally cooling to ambient temperature.

### CONTRASTING EXAMPLE 5

The nanoporous g-C₃N₄ from Implementation Example 1 of CN103240121 is selected as a contrasting example, and its specific surface area and photocatalytic activity are tested.

Activity Test and Characterization

A series of characterizations including XRD, FERTEM, BET surface area and pore size distribution and photocatalytic activity test are adopted on the g-C₃N₄ samples from the implementation and contrasting examples. The detailed methods are presented below:

XRD:

The crystal phase is characterized by X-ray Diffraction (XRD) (X′ PERT-PRO MPD) with a Cu_{Kα} irradiation (λ=0.15406 nm) from Panalytical B. V.

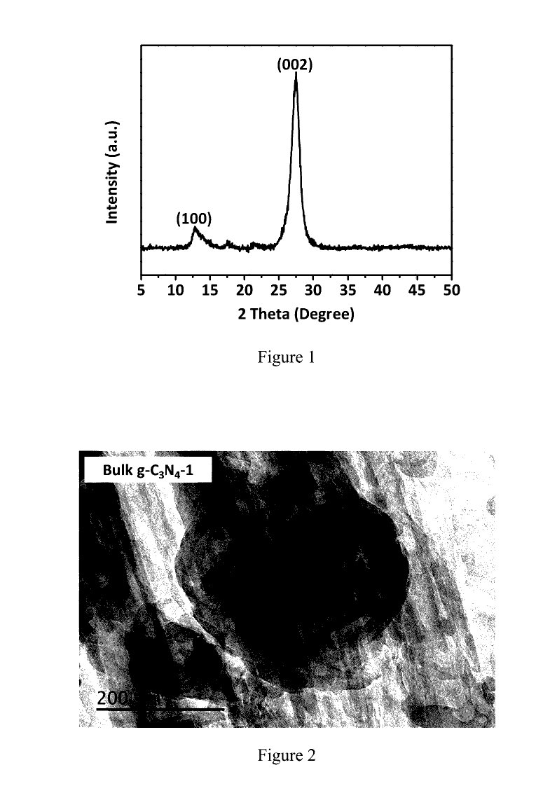

FIG. 1 shows an XRD pattern of the honeycomb-like nanoporous g-C₃N₄ material in Implementation Example 1. The intensive diffraction peak at 27.4° was an interlayer stacking peak of aromatic systems as indexed as the (0 0 2) plane, and the relatively weak peak at 13.0° labeled as the (1 0 0) plane corresponding to the in-plain structural packing motif of tris-triazine units.

FETEM:

The morphologies and structures of the prepared samples are further investigated by field-emission transmission electron microscopy (FETEM, JEM-2100F, JEOL, Japan).

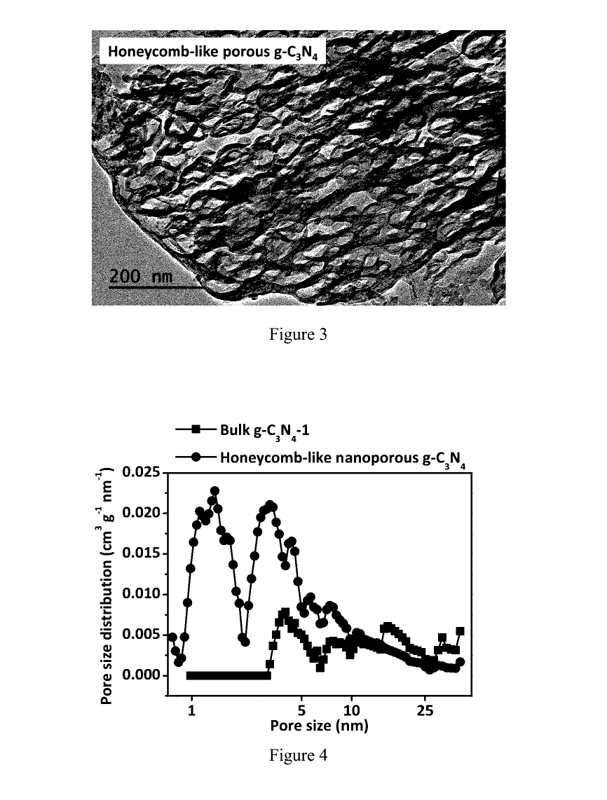

FIG. 2 shows a field-emission transmission electron microscopy (FETEM) image of the bulk g-C3N4-1. FIG. 3 shows an FETEM image of the honeycomb-like nanoporous g-C₃N₄ material in Implementation Example 1. It can be seen that the g-C₃N₄ sample synthesized by Implementation Example 1 exhibits a honeycomb-like porous structure, while the bulk g-C₃N₄-1 displays dense and thick sheet-structured morphology.

BET Surface Area and Pore Size Distribution:

The Brunauer-Emmett-Teller (BET) surface areas are measured by an automated gas sorption analyzer (Autosorb-iQ, Quantachrome, USA) at the temperature of liquid nitrogen (77K). Pore size distributions are calculated with the non-localized density functional theory method using adsorption data.

Photocatalytic Activity Test:

The photocatalytic degradation is carried out at 25° C. under visible light (420-800 nm) irradiation in a 450 mL cylindrical borosilicate glass reactor with a quartz cap, containing 300 mL of solution with 20 mg/L of p-hydroxybenzoic acid and 0.5 g/L of catalyst. Visible light is provided by a 300 W Xenon lamp (CEL-NP2000, Aulight Co., Ltd., China) with a visible-light reflector and a 420 nm cutoff filter. The average radiant flux is 200 mW/cm², measured by a photometer (CEL-NP2000, Aulight Corporation, China). The concentrations of p-hydroxybenzoic acid is analyzed by high performance liquid chromatography (HPLC, Agilent series 1200, USA) equipped with a Zorbax SB-Aq column and a UV-vis detector qualified at 240 nm. The p-hydroxybenzoic acid degradation rate constants are calculated in the presence of the g-C₃N₄ samples from the implementation and contrasting examples to characterize the photocatalytic activities.

The corresponding results are listed below:

TABLE 1
The specific surface areas and p-hydroxybenzoic acid
degradation rate constants of the g-C₃N₄ samples from
the Implementation and Contrasting Examples

Item

| No. | | S_{BET} (m²/g) | kₐₚₚ^{a} (×10⁻² mg/L · min) |
|---|---|---|---|
| Implementation | 1 | 118.3 | 6.9 |
| Examples | 2 | 128.7 | 7.5 |
| | 3 | 178.7 | 8.6 |
| | 4 | 110.7 | 6.0 |
| | 5 | 100.8 | 5.9 |
| Contrasting | 1 | 15.0 | 3.3 |
| Examples | 2 | 8.9 | 2.8 |
| | 3 | 35.9 | 3.9 |
| | 4 | 29.5 | 3.8 |
| | 5 | 29.6 | 3.7 |

^{a}p-hydroxybenzoic acid degradation rate constant.

FIG. 4 shows a comparison curve of the pore size distributions of the honeycomb-like nanoporous g-C₃N₄ material from Implementation Example 1 and the bulk g-C₃N₄-1 from Contrasting Example 1. It confirms that the honeycomb-like nanoporous g-C₃N₄ material has both abundant micropores (1.4 nm) and small mesopores (3.0, 4.2, 5.7 and 7.5 nm), while the bulk g-C₃N₄-1 has few nanopores.

It can be seen from Table 1 that the specific surface area of the honeycomb-like nanoporous g-C₃N₄ material (from Implementation Example 1) is 6.8 times as high as that of the bulk g-C₃N₄-1 (from Contrasting Example 1), and the corresponding p-hydroxybenzoic acid degradation rate is about 2 times as large as that of the bulk g-C₃N₄-1. The specific surface area of the honeycomb-like nanoporous g-C₃N₄ material (from Implementation Example 2) increases 13.4 times compared to that of the bulk g-C₃N₄-2 (from Contrasting Example 2), and a 1.7 times enhancement of p-hydroxybenzoic acid degradation rate occurs on the honeycomb-like nanoporous sample in comparison with the bulk g-C₃N₄-2. A 4 times improvement of the specific surface area can be seen from the honeycomb-like nanoporous g-C₃N₄ material (from Implementation Example 3) compared with the bulk g-C₃N₄-3 (from Contrasting Example 3), and correspondingly, its photocatalytic activity increases 1.2 times in treating p-hydroxybenzoic acid. Compared to the nanoporous sample (from Contrasting Example 4), a 2.7 times improvement of the specific surface area occurs on the honeycomb-like nanoporous g-C₃N₄ material (from Implementation Example 4), and a 70% higher p-hydroxybenzoic acid degradation rate is also observed. The specific surface area of the honeycomb-like nanoporous g-C₃N₄ material (from Implementation Example 5) exhibits a 2.4 times increase compared to that of the nanoporous sample (from Contrasting Example 5), and the p-hydroxybenzoic acid degradation rate increases 50% correspondingly.

The inventor hereby declares that this invention is not limited to the above implementation examples that are used to specify the technical process and equipment, i.e., that this invention can also be implemented without following the above execution details. Based on this inventive concept, any possible change or replacement of the involved materials, reagents and modes of execution belong to the scope of protection.

1. A synthetic method of graphitic carbon nitride material comprising: homogenous mixing of graphitic carbon nitride precursor and ammonium salt; and calcinating to obtain a porous graphitic carbon nitride material, wherein the ammonium salt is any one or a combination of at least two salts capable of releasing gaseous NH₃ during thermolysis.

2. The method of claim 1, wherein the graphitic carbon nitride precursor is any one or a combination of at least two among cyanamide, dicyandiamide, melamine, thiourea and urea.

3. The method of claim 1, wherein the ammonium salt is any one or a combination of at least two among NH₄F, NH₄Cl, NH₄Br, NH₄I, (NH₄)₂CO₃, NH₄HCO₃, NH₄NO₃, (NH₄)₂SO₄, NH₄HSO₄, NH₄H₂PO₄, (NH₄)₂HPO₄, (NH₄)₃PO₄ and (NH₄)₂C₂O₄.

4. The method of claim 1, wherein the mass ratio of the g-C₃N₄ precursor to the ammonium salt is 1:10-10:1.

5. The method of claim 1, wherein the calcination temperature is 400-700° C., and the calcination time is 1-6 hours.

6. The method of claim 1, wherein the homogenous mixing of carbon nitride precursor and ammonium salt further comprises:
dissolving the carbon nitride precursor and ammonium salt in a solvent, followed by removing the solvent.

7. The method of claim 6, wherein the method of removing the solvent is any one or a combination of at least two among spin evaporation, natural evaporation, heating evaporation, freeze drying and vacuum drying.

8. The method of claim 6, wherein the solvent used for dissolving carbon nitride precursor and ammonium salt is ethanol, water or both.

9. The method of claim 6 further comprising: heating and stirring the solution of carbon nitride precursor and ammonium salt at 30-90° C. for 0.5-6 hours to evaporate most solvent; and further removing it all by freeze drying or vacuum drying for 12-48 hours.

10. The method of claim 9, wherein the freeze drying temperature is from −50 to −10° C., and the vacuum drying temperature is 40-80° C.

11. The method of claim 6, wherein a further washing of the calcined product is requisite to remove the residue from the calcination of the selected ammonium salts; the cleaning agent is water, ethanol or both.

12. The method of claim 1, wherein a temperature programmed process is adopted for the calcination to reach the calcination temperature.

13. The method of claim 12, wherein the temperature programmed rate is 0.5-15° C./min.

14. The method of claim 1 further comprising:
(1) mixing the carbon nitride precursor and ammonium salt with a mass ratio of 1:10-10:1 in a solvent to achieve a homogenous mixture;
(2) removing the solvent; and
(3) heating the resultant product to 400-700° C. at a rate of 0.5-15° C./min and calcining for 1-6 hours.

15. The obtained graphitic carbon nitride material synthesized by the method of claim 1, wherein the graphitic carbon nitride material has a honeycomb-like porous structure with a pore volume of 0.20-0.65 cm³/g and a pore size of 2-25 nm.

16. The material of claim 15, wherein the specific surface area of the graphitic carbon nitride material is higher than 100 m²/g.
